(19) United States
(12) Patent Application Publication
(10) Pub. No.: US 2024/0239280 A1
(43) Pub. Date: Jul. 18, 2024

(54) SWITCH SYSTEM AND CONNECTION DEVICE

(71) Applicant: KABUSHIKI KAISHA TOKAI RIKA DENKI SEISAKUSHO, Aichi (JP)

(72) Inventor: Toshinori NAGAKURA, Aichi (JP)

(73) Assignee: KABUSHIKI KAISHA TOKAI RIKA DENKI SEISAKUSHO, Aichi (JP)

(21) Appl. No.: 18/289,635

(22) PCT Filed: Mar. 30, 2022
(86) PCT No.: PCT/JP2022/016225

§ 371 Date: Nov. 6, 2023

(30) Foreign Application Priority Data
May 12, 2021 (JP) 2021-081070

(51) Int. Cl. B60R 16/027; B60K 20/06; B60Q 1/00; B60Q 1/14

(52) U.S. Cl. CPC B60R 16/027; B60K 20/06; B60Q 1/0094; B60Q 1/1476

(57) ABSTRACT

A shift lever switch includes a plurality of first connection terminals and a first circuit using the plurality of first connection terminals in a first electrical configuration. A wiper lever switch includes a plurality of second connection terminals and a second circuit using the plurality of second connection terminals in a second electrical configuration different from the first electrical configuration. A processor is configured to determine whether a switch connected to the connector is the shift lever switch or the wiper lever switch, based on whether a plurality of connection terminals of the switch connected to a right connector are used in the first electrical configuration or the second electrical configuration.

### TECHNICAL FIELD

The presently disclosed subject matter relates to a switch system to be installed in a vehicle. The presently disclosed subject matter also relates to a connection device forming a part of the switch system and to which a switch is connected.

### BACKGROUND ART

Japanese Patent Publication No. 2008-105674 discloses a lever switch attached to a steering wheel of a vehicle. The lever switch is configured as a switch for receiving an operation input of a driver for lighting a lamp for notifying a surrounding of the vehicle of a change in the course of the vehicle.

### SUMMARY OF INVENTION

### Technical Problem

It is demanded to suppress an increase in a component cost and a management cost relating to a switch system.

### Solution to Problem

In order to meet the above demand, an aspect of the presently-disclosed subject matter provides a switch system to be installed in a vehicle, comprising:
a first switch including a plurality of first connection terminals and a first circuit using the plurality of first connection terminals in a first electrical configuration, the first switch having a first function for changing a shift position of the vehicle;
a second switch including a plurality of second connection terminals having the same configuration as the plurality of first connection terminals and a second circuit using the plurality of second connection terminals in a second electrical configuration different from the first electrical configuration, the second switch having a second function different from the first function;
a connection device including a connector to which either the first switch or the second switch is connectable; and
a processor configured to determine whether a switch connected to the connector is the first switch or the second switch, based on whether a plurality of connection terminals of the switch connected to the connector are used in the first electrical configuration or the second electrical configuration.

In order to meet the above demand, an aspect of the presently-disclosed subject matter provides a connection device to be installed in a vehicle, comprising:
a connector to which either a first switch or a second switch is connectable, the first switch including a plurality of first connection terminals and a first circuit using the plurality of first connection terminals in a first electrical configuration, the first switch having a first function for changing a shift position of the vehicle, the second switch including a plurality of second connection terminals having the same configuration as the plurality of first connection terminals and a second circuit using the plurality of second connection terminals in a second electrical configuration different from the first electrical configuration, the second switch having a second function different from the first function; and
a processor configured to determine whether a switch connected to the connector is the first switch or the second switch, based on whether a plurality of connection terminals of the switch connected to the connector are used in the first electrical configuration or the second electrical configuration.

The first switch having a first function for changing the shift position of the vehicle and the second switch having a second function different from the first function generally have different shapes of the connecting portion connected to the connector of the connecting device. In this case, a dedicated connection device must be prepared for each of the first switch and the second switch, which may lead to an increase in the component cost and the management cost relating to the switch system. On the other hand, according to the configuration according to each of the above aspects, since the first switch and the second switch to be selectively used have the same terminal configuration, the specification of the connector of the connection device can be made common. In other words, it is not necessary to prepare a dedicated connection device for each of the first switch and the second switch to be selectively used. Since at least the number of items on the connection device side can be reduced, it is possible to suppress an increase in the component cost and the management cost relating to the switch system. In addition, when either the first switch or the second switch is connected to the connector, since the connected switch is specified based on the difference in the electrical configuration, it is possible to eliminate an additional operation for causing the connection device to identify the switch.

### BRIEF DESCRIPTION OF DRAWINGS

FIG. 1 illustrates an exemplary configuration of a switch system according to an embodiment.

FIG. 2 illustrates an exemplary functional configuration of the switch system.

FIG. 3 illustrates a configuration example of a right connector of a connection device and a connection portion of a switch.

### DESCRIPTION OF EMBODIMENTS

Embodiments will be described in detail below with reference to the accompanying drawings. In each of the drawings used in the following description, the scale is appropriately changed in order to make each element have a recognizable size.

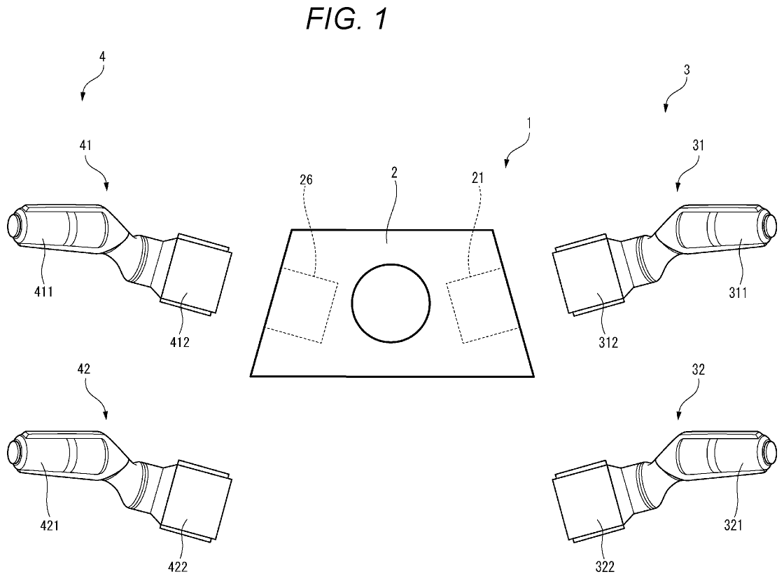

FIG. 1 illustrates a switch system 1 according to an embodiment. The switch system 1 forms a part of a steering column module to be installed in a vehicle. As used in the following description, the expressions “left” and “right” mean a direction seen from a driver of the vehicle.

The switch system 1 includes a connection device 2. The connection device 2 is attached to a steering shaft (not illustrated) of the vehicle. The connection device 2 includes a right connector 21. The right connector 21 is an example of the connector.

The switch system 1 includes a switch 3. The switch 3 is attached to the right connector 21 of the connection device 2. The switch 3 receives an operation of a driver for controlling the operation of a controlled device provided in the vehicle. Examples of the controlled device include a transmission, a wiper, and various lamps.

The switch 3 includes a shift lever switch 31. The shift lever switch 31 includes an operation portion 311 and a connection portion 312. The operation portion 311 is a portion operated by a driver to change the shift position of the transmission of the vehicle. Examples of the shift position include a reverse position, a neutral position, and a drive position. The shift lever switch 31 can be coupled to the connection device 2 by connecting the connection portion 312 to the right connector 21. The shift lever switch 31 is an example of the first switch.

The switch 3 includes a wiper lever switch 32. The wiper lever switch 32 includes an operation portion 321 and a connection portion 322. The operation portion 321 is a portion to be operated by a driver to actuate at least one of the front window wiper and the rear window wiper. The wiper lever switch 32 can be coupled to the connection device 2 by connecting the connection portion 322 to the right connector 21. The wiper lever switch 32 is an example of the second switch.

That is, either the shift lever switch 31 or the wiper lever switch 32 can be connected to the right connector 21 of the connection device 2.

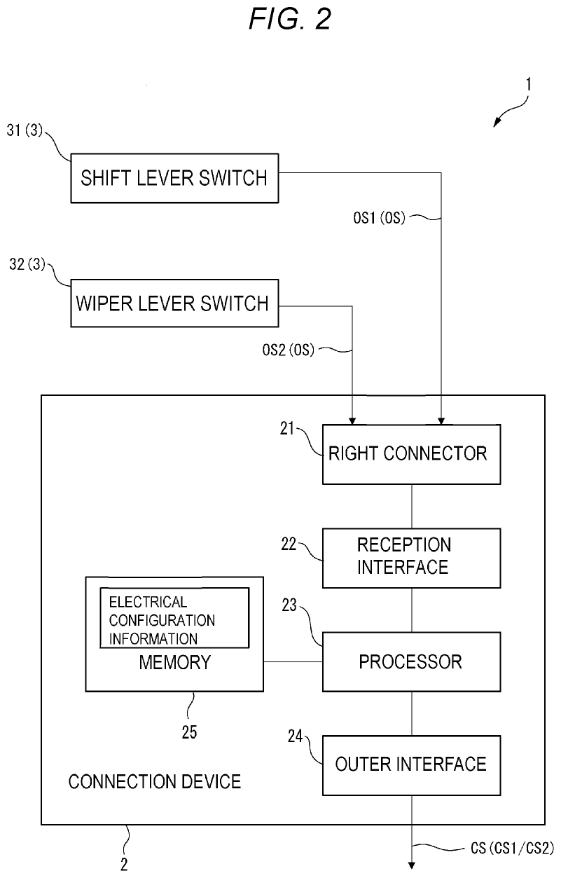

As illustrated in FIG. 2, the connection device 2 includes a reception interface 22, a processor 23, and an output interface 24. The switch 3 connected to the right connector 21 outputs an operation signal OS when it receives an operation of a driver for controlling the operation of a controlled device provided in the vehicle.

The reception interface 22 is configured as an interface capable of receiving the operation signal OS outputted from the switch 3. When the operation signal OS is in the form of analog data, the reception interface 22 includes an appropriate conversion circuit including an A/D converter. The processor 23 sets an operation signal OS in the form of digital data as processing targets.

The processor 23 is configured to output a control signal CS corresponding to the operation of the driver input to the switch 3 from the output interface 24 based on the operation signal OS received by the reception interface 22. The controlled device provided in the vehicle executes a predetermined operation based on the control signal CS. That is, the output unit 24 is configured as an interface for outputting the control signal CS. The control signal CS may be an analog signal or a digital signal. In a case where the control signal CS is an analog signal, the output unit 24 is equipped with an appropriate conversion circuit including a D/A converter.

For example, in a case where the shift lever switch 31 is connected to the right connector 21, the shift lever switch 31 outputs a first operation signal OS1 when it receives an operation of a driver for changing the shift position of the transmission of the vehicle. The processor 23 outputs a first control signal CS 1 from the output interface 24 based on the first operation signal OS1 received by the reception interface 22. The operation of the transmission corresponding to the shift position of the shift lever switch 31 is controlled by the first control signal CS 1. For example, in a case where the wiper lever switch 32 is connected to the right connector 21, the wiper lever switch 32 outputs a second operation signal OS2 when it receives an operation of a driver for actuating at least one of the front windows wiper and the rear windows wiper. The processor 23 outputs a second control signal CS2 from the output interface 24 based on the second operation signal OS2 received by the reception interface 22. The second control signal CS2 controls the operation of at least one of the front window wiper and the rear window wiper corresponding to the wiper lever switch 32.

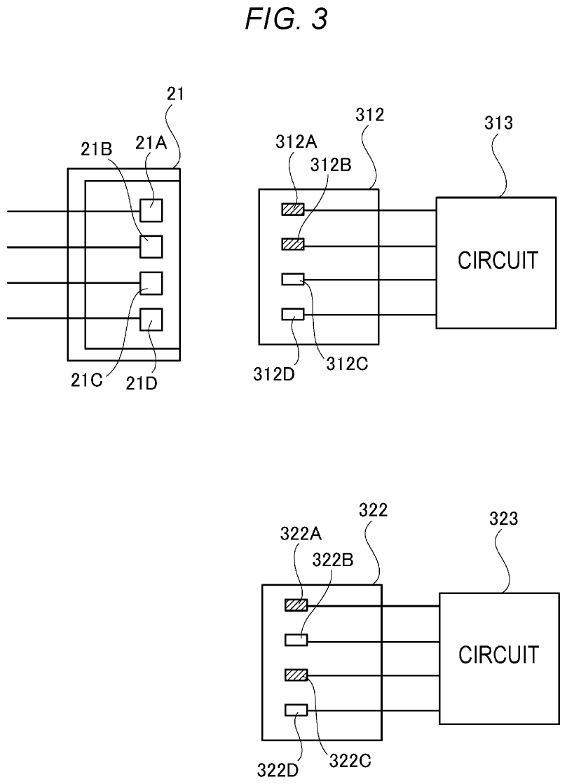

FIG. 3 illustrates a configuration example of the right connector 21 of the connection device 2 and the switch 3 connected to the right connector 21. As illustrated in FIG. 3, the right connector 21 includes a plurality of connection terminals 21A, 21B, 21C, and 21D.

The connection portion 312 of the shift lever switch 31 includes a plurality of first connection terminals 312A, 312B, 312C, and 312D. When the shift lever switch 31 is attached to the right connector 21, the first connection terminal 312A is configured to be connectable to the connection terminal 21A of the right connector 21. Similarly, the first connection terminal 312B is configured to be connectable to the connection terminal 21B of the right connector 21. The first connection terminal 312C is configured to be connectable to the connection terminal 21C of the right connector 21. The first connection terminal 312D is configured to be connectable to the connection terminal 21D of the right connector 21.

The shift lever switch 31 includes a first circuit 313 using a plurality of first connection terminals 312A, 312B, 312C, and 312D in a first electrical configuration. Specifically, the first circuit 313 may be configured to cause the first connection terminals 312A and 312B to output the first operation signal OS1 and not to cause the first connection terminals 312C and 312D to output the first operation signal OS1 when the operation portion 311 is operated by a driver, for example. For example, the potentials of the first connection terminals 312C and 312D can be set to the ground potential by the first circuit 313.

Similarly, the connection portion 322 of the wiper lever switch 32 includes a plurality of second connection terminals 322A, 322B, 322C, and 322D. When the wiper lever switch 32 is attached to the right connector 21, the second connection terminal 322A is configured to be connectable to the connection terminal 21A of the right connector 21. Similarly, the second connection terminal 322B is configured to be connectable to the connection terminal 21B of the right connector 21. The second connection terminal 322C is configured to be connectable to the connection terminal 21C of the right connector 21. The second connection terminal 322D is configured to be connectable to the connection terminal 21D of the right connector 21.

The wiper lever switch 32 includes a second circuit 323 using a plurality of second connection terminals 322A, 322B, 322C, and 322D in a second electrical configuration. Specifically, the second circuit 323 may be configured to cause the second connection terminals 322A and 322C to output the second operation signal OS2 and not to cause the second connection terminals 322B and 322D to output the second operation signal OS2 when the operation portion 321 is operated by, for example, a driver. For example, the potentials of the second connection terminals 322B and 322D can be set to the ground potential by the second circuit 323.

That is, the plurality of first connection terminals 312A, 312B, 312C, and 312D and the plurality of second connection terminals 322A, 322B, 322C, and 322D have the same configuration (the same arrangement and the same number). On the other hand, the first electrical configuration of the plurality of first connection terminals 312A, 312B, 312C, and 312D and the second electrical configuration of the plurality of second connection terminals 322A, 322B, 322C, and 322D are different from each other.

When the switch 3 is connected to the right connector 21, the processor 23 of the connection device 2 is configured to determine whether the switch 3 connected to the right connector 21 is the shift lever switch 31 or the wiper lever switch 32 based on whether a plurality of connection terminals of the switch 3 connected to the right connector 21 are used in the first electrical configuration or the second electrical configuration.

As illustrated in FIG. 2, the connection device 2 may include a memory 25. In the memory 25, information relating to the first electrical configuration of the plurality of first connection terminals 312A, 312B, 312C, and 312D of the shift lever switch 31 is stored in advance. For example, information indicating that the terminals not used for transmitting a signal caused by the switch operation by being set to the ground potential are the first connection terminals 312A and 312B is stored.

Similarly, in the memory 25, information relating to the second electrical configuration of the plurality of second connection terminals 322A, 322B, 322C, and 322D of the wiper lever switch 32 is stored in advance. For example, information indicating that the terminals not used for transmitting a signal caused by the switch operation by being set to the ground potential are the second connection terminals 322A and 322C is stored.

The processor 23 is configured to detect the potential of each of the connection terminals 21 A to 21D when the switch 3 is connected to the right connector 21. Subsequently, the processor 23 is configured to specify the type of the switch 3 connected to the right connector 21 by comparing the potential of each of the detected connection terminals with the information stored in the memory 25.

For example, when the wiper lever switch 32 is connected to the right connector 21, it is detected that the connection terminals 21A and 21C are at the ground potential. Since information indicating that the switch 3 in which the second connection terminals 322A and 322C corresponding to the connection terminal are fixed to the ground potential is the wiper lever switch 32 is stored in the memory 25, the processor 23 can specify that the switch 3 connected to the right connector 21 is the wiper lever switch 32.

The shift lever switch 31 and the wiper lever switch 32 generally have different shapes of connecting portions connected to the right connector 21 of the connecting device 2. In this case, it is necessary to prepare a dedicated connection device 2 for each of the shift lever switch 31 and the wiper lever switch 32, which may lead to an increase in the component cost and the management cost relating to the switch system 1.

On the other hand, according to the configuration of the present embodiment, since the shift lever switch 31 and the wiper lever switch 32 to be selectively used have the same terminal configuration, the specification of the right connector 21 of the connection device 2 can be made common. In other words, it is not necessary to prepare a dedicated connection device 2 for each of the shift lever switch 31 and the wiper lever switch 32 to be selectively used. Since at least the number of items on the connection device 2 side can be reduced, it is possible to suppress an increase in the component cost and the management cost relating to the switch system 1. In addition, when either the shift lever switch 31 or the wiper lever switch 32 is connected to the right connector 21, since the switch connected is specified based on the difference in the electrical configuration, it is possible to eliminate an additional operation for causing the connection device 2 to identify the switch.

As illustrated in FIG. 1, the connection device 2 may include a left connector 26. The left connector 26 is connected to the processor 23 via a reception interface (not illustrated). The switch system 1 may include a switch 4 attached to the left connector 26. The switch 4 includes a first lever switch 41 and a second lever switch 42.

The first lever switch 41 and the second lever switch 42 have at least one function different from each other. For example, the first lever switch 41 is a switch for receiving an operation of a driver for lighting a headlight of the vehicle and a lamp for notifying the surroundings of the vehicle of a change in the course of the vehicle. For example, the second lever switch 42 is a switch for receiving an operation of a driver for lighting a headlight of the vehicle and a lamp for notifying the surroundings of the vehicle of a change in the course of the vehicle, and an operation of the driver for actuating at least one of the front windows wiper and the rear windows wiper.

The first lever switch 41 includes an operation portion 411 and a connection portion 412. The operation portion 411 is a portion to be operated by a driver. The first lever switch 41 can be coupled to the connection device 2 by connecting the connection portion 412 to the left connector 26. Similarly, the second lever switch 42 includes an operation portion 421 and a connection portion 422. The operation portion 421 is a portion to be operated by a driver. The second lever switch 42 can be coupled to the connection device 2 by connecting the connection portion 422 to the left connector 26.

That is, either the first lever switch 41 or the second lever switch 42 is configured to be connected to the left connector 26 of the connection device 2.

Although not illustrated and described in detail, the first lever switch 41 and the second lever switch 42 have a plurality of connection terminals having the same configuration (the same arrangement and the same number) and different electrical configurations, similarly to the switch 3. When the switch 4 is connected to the left connector 26, the processor 23 of the connection device 2 may be configured to determine whether the switch 4 connected to the left connector 26 is the first lever switch 41 or the second lever switch 42 based on the electrical configuration of the plurality of connection terminals of the switch 4 connected to the left connector 26.

Even in such a configuration, since the first lever switch 41 and the second lever switch 42 to be selectively used have the same terminal configuration, the specification of the left connector 26 of the connection device 2 can be made common. In other words, it is not necessary to prepare a dedicated connection device 2 for each of the first lever switch 41 and the second lever switch 42 to be selectively used. Since at least the number of items on the connection device 2 side can be reduced, it is possible to suppress an increase in the component cost and the management cost relating to the switch system 1. In addition, when either the first lever switch 41 or the second lever switch 42 is connected to the left connector 26, since the switch connected is specified based on the difference in the electrical configuration, it is possible to eliminate an additional operation for causing the connection device 2 to identify the switch.

The processor 23 having each function described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of the non-transitory computer-readable medium stored in the computer program. The general-purpose microprocessor designates at least a part of the computer program stored in the ROM, loads the program on the RAM, and executes the processing described above in cooperation with the RAM. The above-described computer program may be pre-installed in the general-purpose memory, or may be downloaded from the external server device via the communication network and then installed in the general-purpose memory. In this case, the external server device is an example of the non-transitory computer-readable medium having stored the computer program.

The processor 23 may be implemented by an exclusive integrated circuit capable of executing the above-described computer program. Examples of the exclusive integrated circuit include a microcontroller, an ASIC, and an FPGA. In this case, the above-described computer program is pre-installed in a memory element included in the exclusive integrated circuit. The memory element is an example of a non-transitory computer-readable medium having stored a computer program. The processor 23 may also be implemented by a combination of the general-purpose microprocessor and the exclusive integrated circuit.

The memory 25 may be implemented by a general-purpose memory operating in cooperation with a general-purpose microprocessor. The memory 25 can store a computer program corresponding to all the types of the switch 3 connectable to the right connector 21 and all the types of the switch 4 connectable to the left connector 26. In this case, the processor 23 designates and executes a computer program corresponding to the switch 3 or the switch 4 specified from the plurality of computer programs stored in the memory 25. Alternatively, the computer program stored in the memory 25 may be appropriately rewritten in accordance with the switch 3 connected to the right connector 21 or the switch 4 connected to the left connector 26. In this case, the computer program corresponding to the switch 3 or the switch 4 to be connected may be downloaded from the external server device via the wireless communication network before or after the switch 3 or the switch 4 is connected to the connector, and then installed in the memory 25. Alternatively, the switch 3 or the switch 4 may have a memory for storing a corresponding computer program, and when the switch 3 or the switch 4 is connected to the connector, the computer program may be downloaded from the switch 3 or the switch 4 and then installed in the memory 25.

The above embodiments are merely illustrative for facilitating understanding of the gist of the presently disclosed subject matter. The configuration according to each of the above embodiments can be appropriately modified or combined without departing from the gist of the presently disclosed subject matter.

In the above embodiment, the potential of each connection terminal is used as information indicating the electrical configuration of the connection terminal for specifying the type of the switch 3 connected to the right connector 21 of the connection device 2. However, as long as a plurality of types of switches 3 can be distinguished from each other, the resistance value of each connection terminal and the like can be used as the information indicating the electrical configuration of the connection terminal.

In the above embodiment, a case is illustrated in which the number of the connection terminals of the right connector 21 and the number of the connection terminals of the switch 3 are four. However, the number of connection terminals of the right connector 21 and the connection terminal of the connection portion of the switch 3 may be increased or decreased according to, for example, the number of the switches 3 connectable to the right connector 21 or the function of the switch 3. As the electrical configuration of the connection terminal of the switch 3, a configuration other than that in FIG. 3 may be employed.

In the above embodiment, it is illustrated that the number of lever switches selectively connected to a specific connector in the connection device 2 is two. However, the number of lever switches selectively connectable to a specific connector may be three or more. In this case, the memory 25 of the connection device 2 may store information relating to the electrical configuration of the connection terminals associated with three or more lever switches selectively connectable to the connector.

In the above embodiment, the switch 3 includes a wiper lever switch 32 as a switch different from the function of the shift lever switch 31. However, the switch 3 may have a switch having another function, such as a switch for lighting various lamps.

In the above embodiment, a lever switch is cited as an example of the switch. However, the switch may be another type of switch, such as a button switch or a dial switch.

In the above embodiment, the connection device 2 includes a processor 23 and a memory 25. However, at least one of the processor 23 and the memory 25 does not necessarily have to share the housing of the device with the right connector 21. As long as a predetermined function can be exhibited, at least one of the processor 23 and the memory 25 can be disposed at an appropriate position in the vehicle. For example, the processor 23 may be configured by a processor of a vehicle control device for controlling the operation of various controlled devices connected to the vehicle.

The above embodiment illustrates a case in which the connection device 2 forms a part of the steering column module. However, the presently disclosed subject matter is applicable to an appropriate vehicle switch system in which any of a plurality of switches having different functions can be selectively connected to a connector included in a common connection device.

The present application is based on Japanese Patent Application No. 2021-081070 filed on May 12, 2021, the entire contents of which are incorporated herein by reference.

1. A switch system to be installed in a vehicle, comprising:
a first switch including a plurality of first connection terminals and a first circuit using the plurality of first connection terminals in a first electrical configuration, the first switch having a first function for changing a shift position of the vehicle;
a second switch including a plurality of second connection terminals having the same configuration as the plurality of first connection terminals and a second circuit using the plurality of second connection terminals in a second electrical configuration different from the first electrical configuration, the second switch having a second function different from the first function;
a connection device including a connector to which either the first switch or the second switch is connectable; and
a processor configured to determine whether a switch connected to the connector is the first switch or the second switch, based on whether a plurality of connection terminals of the switch connected to the connector are used in the first electrical configuration or the second electrical configuration.

2. The switch system according to claim 1,
wherein the connection device forms a part of a steering column module of the vehicle.

3. A connection device to be installed in a vehicle, comprising:
a connector to which either a first switch or a second switch is connectable, the first switch including a plurality of first connection terminals and a first circuit using the plurality of first connection terminals in a first electrical configuration, the first switch having a first function for changing a shift position of the vehicle, the second switch including a plurality of second connection terminals having the same configuration as the plurality of first connection terminals and a second circuit using the plurality of second connection terminals in a second electrical configuration different from the first electrical configuration, the second switch having a second function different from the first function; and
a processor configured to determine whether a switch connected to the connector is the first switch or the second switch, based on whether a plurality of connection terminals of the switch connected to the connector are used in the first electrical configuration or the second electrical configuration.
